(19) United States
(12) Patent Application Publication
(10) Pub. No.: US 2013/0290605 A1
(43) Pub. Date: Oct. 31, 2013

(54) CONVERGED MEMORY AND STORAGE SYSTEM

(71) Applicant: Moon J. Kim, Wappingers Falls, NY (US)

(72) Inventor: Moon J. Kim, Wappingers Falls, NY (US)

(21) Appl. No.: 13/459,457

(22) Filed: Apr. 30, 2012

(51) Int. Cl. G06F 12/02

(52) U.S. Cl. 711/103; 711/E12.008

(57) ABSTRACT

Embodiments of the present invention provide an approach for Dynamic Random Access Memory (DRAM) and flash converged memory and storage. Specifically, in a typical embodiment, at least one substrate will be provided on which a DRAM unit and flash memory unit are positioned. A set (e.g., one or more of input/outputs (I/Os)) may be provided for the units. Such a set of I/Os may communicate storage and/or memory access requests to a set (e.g., one or more) of controllers, which control the DRAM and flash memory units. The set of controllers may comprise a single integrated controller or multiple controllers having separate and distinct functions (e.g., a memory controller, a storage controller, a DRAM controller, a flash controller, etc.).

### FIELD OF THE INVENTION

In general, embodiments of the present invention provide a converged memory and storage system. Specifically, embodiments of the present invention provide a system having converged Dynamic Random Access Memory (DRAM) and flash memory and storage.

### BACKGROUND OF THE INVENTION

Current mobile systems suffer from power leakage and consumption of semiconductor circuits. Moreover, current low-power circuits are based on conventional design schemes. However, mobile multi-core processor (MCP) implementations require a fundamentally different design approach for cores and on-chip memories. Still yet, strict differences between DRAM and flash fabrication processing and electronic operation requirements significantly constrain innovative solutions. Despite the fact that ONFI (Open NAND Flash Interface) standards limit performance improvements, flash writing and read times are currently insufficient to meet demands and/or needs.

U.S. Pat. No. 6,952,366 discloses a memory device that is comprised of a dynamic random access memory (DRAM) capacitor and a nitride read only memory (NROM) transistor.

U.S. Pat. No. 7,072,213 also discloses a memory device that is comprised of a dynamic random access memory (DRAM) capacitor and a nitride read only memory (NROM) transistor.

U.S. Pat. No. 7,319,613 discloses a memory device that provides multiple modes of operation including a DRAM mode using a capacitor and a non-volatile random access memory mode using the NROM transistor.

U.S. Pat. No. 7,452,222 discloses a mobile computing hard disk drive having both a flash memory device and a DRAM device, with a high density drive (HDD) controller managing data storage between disk, DRAM, and flash both when write requests arrive and when the HDD is idle to optimize flash memory device life and system performance.

U.S. Pat. No. 7,961,498 discloses a DRAM cell comprising a leakage compensation circuit.

U.S. Patent Application Publication No. 20120017065 discloses a system and method that includes a memory die, residing on a stacked memory, which is organized into a plurality of mats that include data.

Unfortunately, none of these approaches addresses the deficiencies in the related art.

### SUMMARY OF THE INVENTION

Embodiments of the present invention provide an approach for Dynamic Random Access Memory (DRAM) and flash converged memory and storage. Specifically, in a typical embodiment, at least one substrate will be provided on which a DRAM unit and flash memory unit are positioned. A set (e.g., one or more of input/outputs (I/Os)) may be provided for the units. Such a set of I/Os may communicate storage and/or memory access requests to a set (e.g., one or more) of controllers, which control the DRAM and flash memory units. The set of controllers may comprise a single integrated controller or multiple controllers having separate and distinct functions (e.g., a memory controller, a storage controller, a DRAM controller, a flash controller, etc.).

A first aspect of the present invention provides a converged memory and storage system, comprising: at least one substrate; a dynamic random access memory (DRAM) unit positioned on the at least one substrate; a flash memory unit positioned on the at least one substrate; a set of controllers coupled to the DRAM unit and the flash memory unit; and a set of input/outputs (I/Os) coupled to the set of controllers for receiving requests to access the DRAM unit or the flash memory unit.

A second aspect of the present invention provides a converged memory and storage system, comprising: a first input/output (I/O); a memory controller coupled to the first I/O; a dynamic random access memory (DRAM) controller coupled to the memory controller; a DRAM unit coupled to the DRAM controller; a second I/O; a storage controller coupled to the second I/O; a flash controller coupled to the storage controller; and a flash memory unit coupled to the flash controller.

A third aspect of the present invention provides a method for converged memory and storage operation, comprising: virtualizing memory access across Dynamic Random Access Memory (DRAM) and flash memory via a memory controller; virtualizing storage access across the DRAM and the flash memory via a storage controller; maintaining a DRAM buffer in the flash memory via a flash controller and a DRAM controller; and maintaining a flash buffer in the DRAM via the flash controller and the DRAM controller.

### BRIEF DESCRIPTION OF THE DRAWINGS

These and other features of this invention will be more readily understood from the following detailed description of the various aspects of the invention taken in conjunction with the accompanying drawings in which:

FIG. 1A depicts a diagram of a single substrate system having converged DRAM and flash memory and storage according to an embodiment of the present invention.

FIG. 1B depicts a diagram of a multi-substrate view of the system of FIG. 1A according to an embodiment of the present invention.

FIG. 2 depicts a diagram of a 3-dimensional integrated packaging view of hybrid DRAM-flash chips according to an embodiment of the present invention.

FIG. 3 depicts a diagram of a 3-dimensional integrated packaging view of hybrid DRAM-flash chips according to an embodiment of the present invention.

FIGS. 4A-B depicts diagrams of a system operation internal cross-over according to an embodiment of the present invention.

FIG. 5 depicts a diagram of an external cross-over access according to an embodiment of the present invention.

FIG. 6 depicts a diagram of a system having converged and virtualized memory and storage access according to an embodiment of the present invention.

FIG. 7A depicts a diagram of a system having a single input/output (I/O) interface for converged operation according to an embodiment of the present invention.

FIG. 7B depicts a diagram of logical implementation of the system of FIG. 7A according to an embodiment of the present invention.

FIG. 8 depicts converged memory and storage active operation according to an embodiment of the present invention.

FIG. 9 depicts direct and virtualized memory access according to an embodiment of the present invention.

FIG. 10 depicts direct and virtualized storage access according to an embodiment of the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION

Illustrative embodiments will now be described more fully herein with reference to the accompanying drawings, in which exemplary embodiments are shown. This disclosure may, however, be embodied in many different forms and should not be construed as limited to the exemplary embodiments set forth herein. Rather, these exemplary embodiments are provided so that this disclosure will be thorough and complete and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an”, and “the” are intended to include the plural forms as well, unless the context clearly indicates otherwise. Furthermore, the use of the terms “a”, “an”, etc., do not denote a limitation of quantity, but rather denote the presence of at least one of the referenced items. The term “set” is intended to mean a quantity of at least one. It will be further understood that the terms “comprises” and/or “comprising”, or “includes” and/or “including”, when used in this specification, specify the presence of stated features, regions, integers, steps, operations, elements, and/or components, but do not preclude the presence or addition of one or more other features, regions, integers, steps, operations, elements, components, and/or groups thereof.

Embodiments of the present invention provide an approach for Dynamic Random Access Memory (DRAM) and flash converged memory and storage. Specifically, in a typical embodiment, at least one substrate will be provided on which a DRAM unit and flash memory unit are positioned. A set (e.g., one or more of input/outputs (I/Os)) may be provided for the units. Such a set of I/Os may communicate storage and/or memory access requests to a set (e.g., one or more) of controllers, which control the DRAM and flash memory units. The set of controllers may comprise a single integrated controller or multiple controllers having separate and distinct functions (e.g., a memory controller, a storage controller, a DRAM controller, a flash controller, etc.).

Dynamic random access memory (DRAM) is a type of random access memory (RAM) for personal computers and workstations. The network of electrically-charged points in which a computer stores quickly accessible data in the form of 0s and 1s is called memory. Random access means that the PC processor can access any part of the memory directly rather than having to proceed sequentially from some starting place. DRAM is dynamic in that, unlike static RAM (SRAM), it needs to have its storage cells refreshed or given a new electronic charge every few milliseconds. Static RAM does not need refreshing because it operates on the principle of moving current that is switched in one of two directions rather than a storage cell that holds a charge in place. Static RAM is generally used for cache memory, which can be accessed more quickly than DRAM. DRAM stores each bit in a storage cell consisting of a capacitor and a transistor. Capacitors tend to lose their charge rather quickly; thus, the need for recharging. A variety of other RAM interfaces to the computer exist. These include: Extended Data Out (EDO), RAM, and SDRAM.

Flash memory is a non-volatile computer storage chip that can be electrically erased and reprogrammed. It was developed from Electrically Erasable Programmable Read-Only Memory (EEPROM) and must be erased in fairly large blocks before these can be rewritten with new data. The high density Negate AND (NAND) type must also be programmed and read in (smaller) blocks, or pages, while the Negate OR (NOR) type allows a single machine word (byte) to be written or read independently.

The NAND type is primarily used in memory cards, USB flash drives, solid-state drives, and similar products, for general storage and transfer of data. The NOR type, which allows true random access and therefore direct code execution, is used as a replacement for the older EPROM and as an alternative to certain kinds of ROM applications. However, NOR flash memory may emulate ROM primarily at the machine code level; many digital designs need ROM (or PLA) structures for other uses, often at significantly higher speeds than (economical) flash memory may achieve. NAND or NOR flash memory is also often used to store configuration data in numerous digital products, a task previously made possible by EEPROMs or battery-powered static RAM. Example applications of both types of flash memory include personal computers, PDAs, digital audio players, digital cameras, mobile phones, synthesizers, video games, scientific instrumentation, industrial robotics, medical electronics, and so on. In addition to being non-volatile, flash memory offers fast read access times, as fast as dynamic RAM, although not as fast as static RAM or ROM. Its mechanical shock resistance helps explain its popularity over hard disks in portable devices; as does its high durability, being able to withstand high pressure, temperature, immersion in water etc.

Although flash memory is technically a type of EEPROM, the term “EEPROM” is generally used to refer specifically to non-flash EEPROM which is erasable in small blocks, typically bytes. Because erase cycles are slow, the large block sizes used in flash memory erasing give it a significant speed advantage over old-style EEPROM when writing large amounts of data. Flash memory now costs far less than byte-programmable EEPROM and has become the dominant memory type wherever a significant amount of non-volatile, solid state storage is needed.

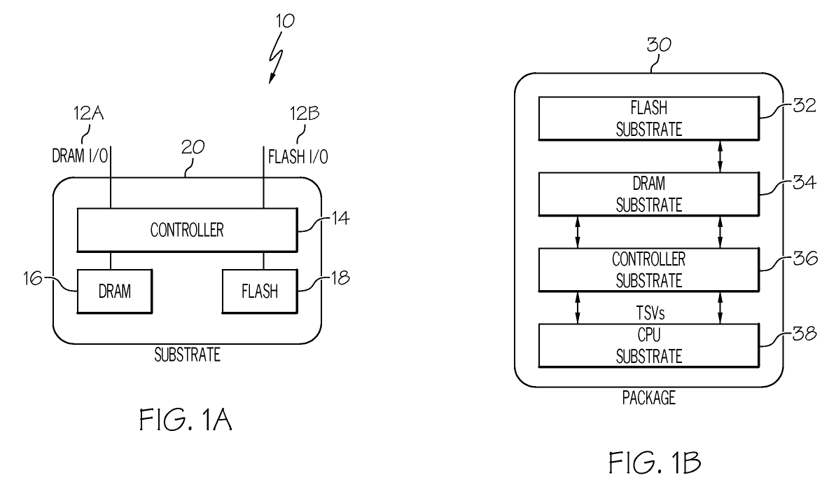

Referring now to FIG. 1A diagram of a single substrate system 10 having converged DRAM and flash memory and storage according to an embodiment of the present invention is depicted. As depicted, system 10 general comprises DRAM I/O 12A, flash I/O 12B, controller 14 (e.g., a memory address-based file system controller) coupled to DRAM I/O 12A and flash I/O 12B, DRAM unit 16 and flash memory unit 18 coupled to controller 14. Moreover, controller 14, DRAM unit 16, and flash memory unit 18 are typically positioned on at least one substrate 20.

As shown in FIG. 1A, DRAM is integrated logically and physically with flash memory as a converged memory and storage subsystem. As further shown, multiple I/Os 12A-B is shown so as to provide a DDR-like channel for DRAM unit 16 and an ONFI-like channel for flash memory unit 18. Further, DRAM unit 16 and flash memory unit 18 may have block management tables. The DRAM area may extend to flash memory when necessary, and vice versa. Under this embodiment, storage requests can be virtually accessed through DRAM I/O 12A, while memory requests can be virtually accessed through flash I/O 12B.

FIG. 1B depicts a multi-substrate view to an embodiment of the present invention. As depicted, FIG. 1B comprises a package 30 having a flash substrate 32, a DRAM substrate 34, a controller substrate 36, and a CPU substrate 38. It is understood that in one embodiment, there may be 1 to 1 ratio of substrates (e.g., DRAM substrate 34 to flash substrate 32). However, this need not be the case. Rather, the embodiments of the present invention may incorporate any ratio (e.g., n to n) of substrates hereunder.

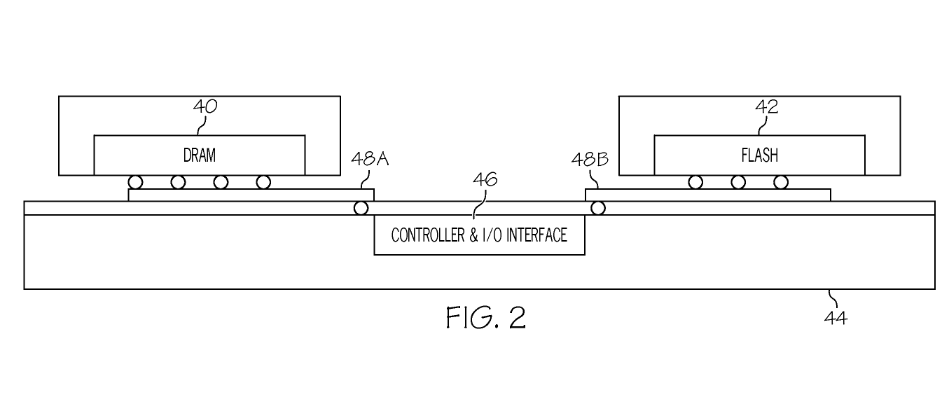

FIG. 2 depicts a diagram of 3-dimensional integrated packaging view of hybrid DRAM-flash chips according to an embodiment of the present invention. As depicted, a DRAM unit/chip 40, a flash memory unit/chip 42 mounted on a controller and I/O interface 46 via interconnects 48A-B (e.g., C4 interconnects, etc.). As further shown, these components may be mounted on a substrate 44 or the like.

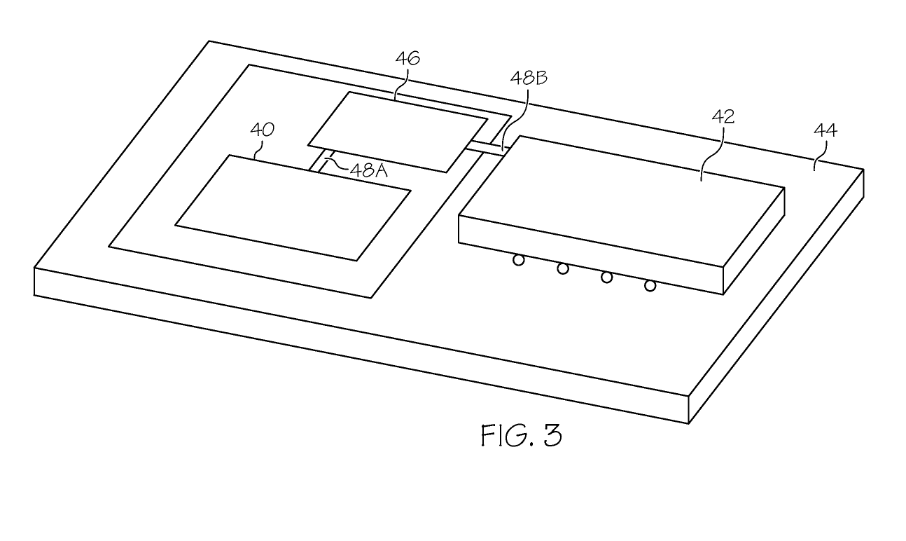

FIG. 3 depicts an isometric view of the approach of FIG. 2. As shown, a DRAM unit 40 and a separate flash memory chip/unit 42 may be attached to a base substrate 44. Both DRAM unit/chip 40 and flash memory unit/chip 42 are further shown attached to controller and I/O interface 46 via interconnects 48A-B.

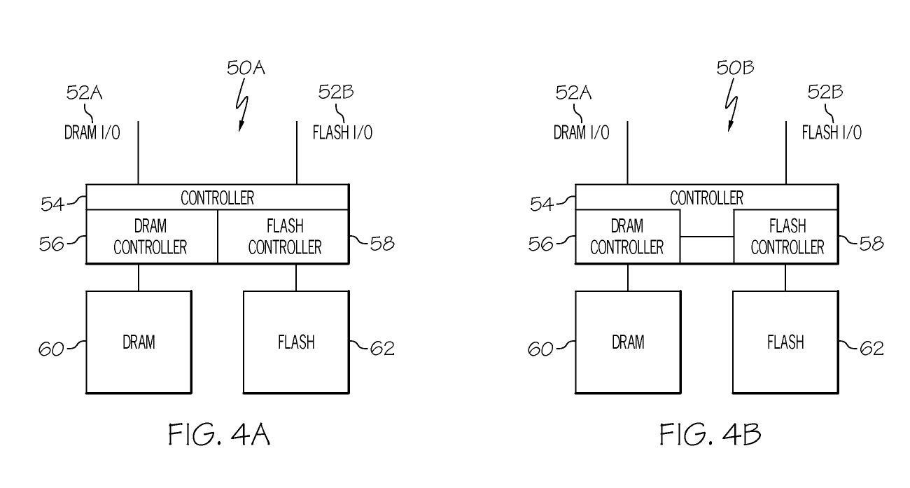

FIGS. 4A-B depicts diagrams of system operation internal cross-over according to an embodiment of the present invention. As shown, similar to FIG. 1A, systems 50A-B each may comprise DRAM I/O 52A, flash I/O 52A-B, controller 54 coupled to DRAM controller 56 and flash controller 58, DRAM unit 60 coupled to DRAM controller, and flash memory unit 62 coupled to flash controller 58. Under the embodiments of FIGS. 4A-B, DRAM unit 60 is accessed through DRAM I/O 52A and DRAM controller 56, while flash memory unit 62 is accessed through flash I/O 52B and flash controller 58. Moreover, DRAM unit 60 and flash memory unit 62 communicate directly between themselves for extended features hereunder.

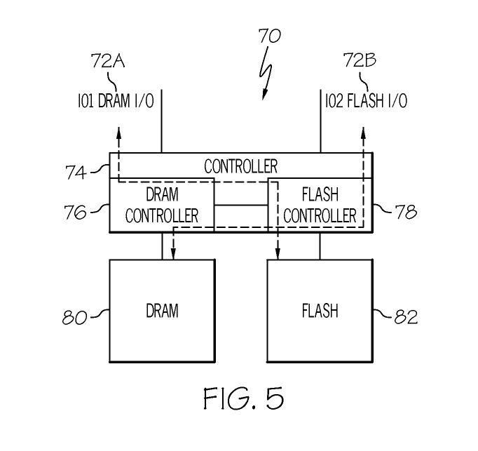

FIG. 5 depicts a diagram of a system 70 having external cross-over access according to an embodiment of the present invention. As shown, similar to FIG. 1A, the system 70 may comprise I/O 72A, I/O 72A-B, controller 74 coupled to DRAM controller 76 and flash controller 78, DRAM unit 80 coupled to DRAM controller, and flash memory unit 82 coupled to flash controller 78. Under the embodiments of FIG. 5, I/O 72A provides access to DRAM unit 80, as well as to flash memory unit 82 through internal cross-over access. Conversely, I/O 72B provides access to flash memory unit 82, as well as to DRAM unit 80 through internal cross-over access. Along these lines, I/O 72A and I/O 72B operate to support both memory and storage data transportation.

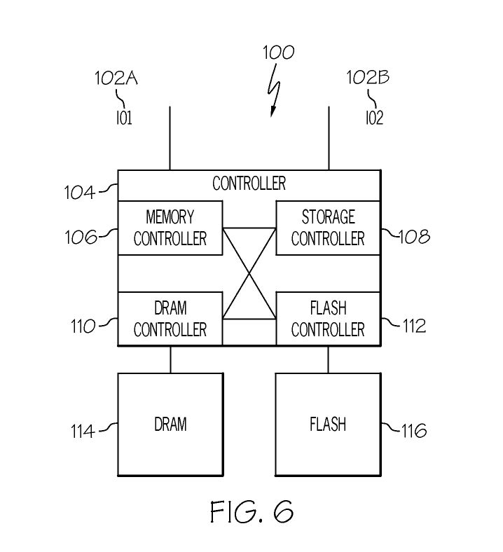

FIG. 6 depicts diagram of a system 100 having converged and virtualized memory and storage access according to an embodiment of the present invention. As shown, system 100 comprises I/O 102A, I/O 102B, main controller 104 having memory controller 106, storage controller 108, DRAM controller 110, and flash controller 112 coupled as shown. System 100 further comprises DRAM unit 114 coupled to DRAM controller 110 and flash memory unit 116 coupled to flash controller 112.

Under system 100 of FIG. 6, I/O 102A accepts memory and storage transaction and provides virtualized memory-level access to DRAM unit 114 and flash unit 116. A direct flash memory access request received at I/O 102A is forwarded to flash controller 112. A storage access request received at I/O 102A is forwarded to storage controller 108. Memory controller 106 and storage controller 108 maintain virtualization and translation tables. I/O 102B accepts storage and memory transactions and provides virtualized storage-level access to DRAM unit 114 and flash memory unit 116. A direct DRAM access request received at I/O 1028 is forwarded to DRAM controller 110 while a memory access request received at I/O 1028 is forwarded to memory controller 106

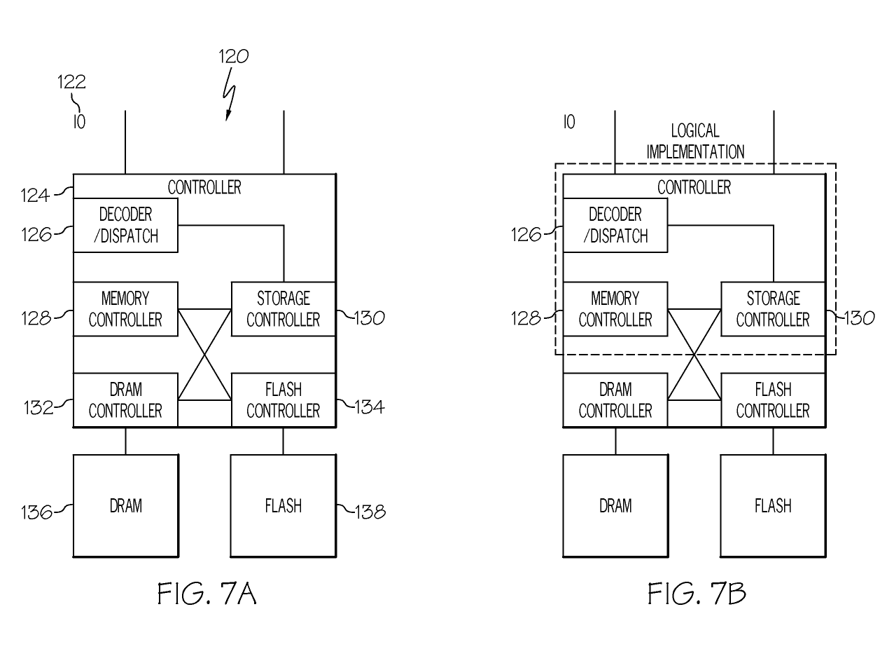

FIG. 7A depicts a diagram of a system 120 having a single input/output (I/O) interface 122 for converged operation according to an embodiment of the present invention. As shown, system 120 comprises I/O 122, main controller 124 having decoder/dispatch 126, memory controller 128, storage controller 130, DRAM controller 132, and flash controller 134 coupled as shown. System 120, further comprises DRAM unit 136 coupled to DRAM controller 132 and flash memory unit 138 coupled to flash controller 134.

Under system 120, controller 124 has a front-end/decoder 126 that decodes the I/O 122. Specifically, decoder 126 decodes and dispatches requests and data. I/O 122 can be packet-based and/or utilize layered protocol to transfer multiple types of data (e.g., PCIe, SPI, HT, QPI, etc.). Moreover, decoder 126 may not only directly forward data based on data type, but decoder 126 may also utilize other paths through system 120 when a given path is busy.

FIG. 7B depicts a logical implementation of the system of FIG. 7A. Specifically, FIG. 7B is intended to demonstrate that any controller configuration described and/or depicted herein may be implemented logically. For example, decoder/dispatch 126, memory controller 128, and/or system controller 130 may be implemented logically to accommodate modular system integration.

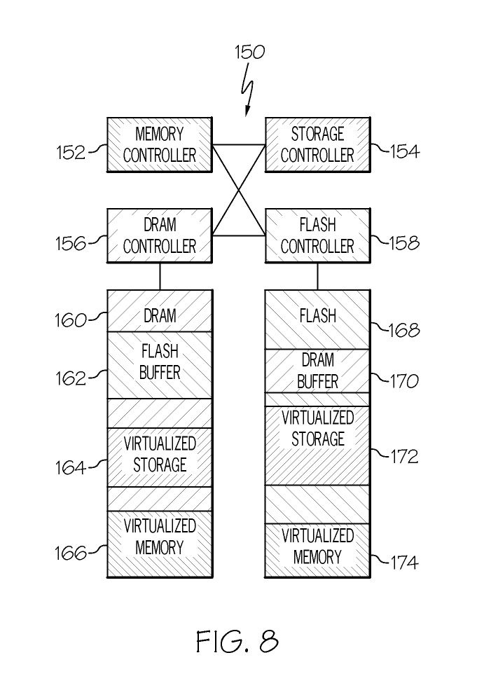

FIG. 8 depicts a system 150 having converged memory and storage active operation according to an embodiment of the present invention. As depicted, system 150 comprises memory controller 152, storage controller 154, DRAM controller 156, and flash controller 158 coupled to one another as shown. Coupled to DRAM controller 156 (e.g., as an integrated unit) are DRAM unit 160, flash buffer 162, virtualized storage 164, and virtualized memory 166. Coupled to flash controller 158 (e.g., as an integrated unit) are flash memory unit 168, DRAM buffer 170, virtualized storage 172, and virtualized memory 174.

Under system 150, memory controller 152 virtualizes memory access across DRAM 160 and flash memory 168. Storage controller 154 virtualizes storage access across flash memory 168 and DRAM 160. DRAM controller 156 works with flash controller 158 to maintain a DRAM buffer 170 in flash memory 168. Similarly, flash controller 158 works with DRAM controller 156 to maintain a flash buffer 162 in DRAM 160.

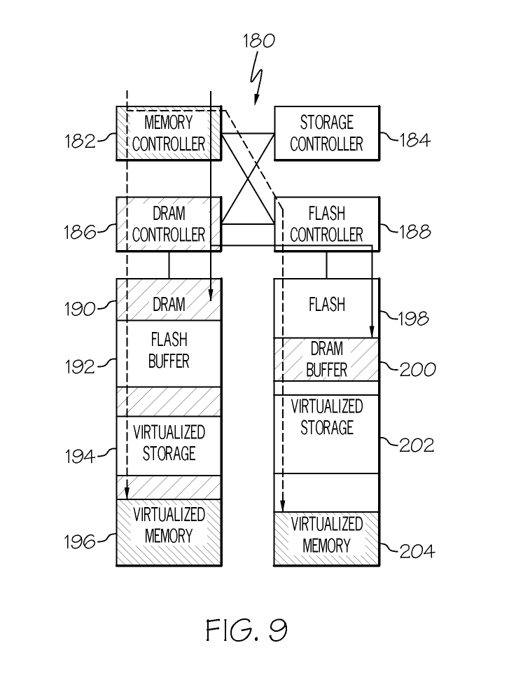

FIG. 9 depicts a system 180 having direct and virtualized memory access according to an embodiment of the present invention. As depicted, system 180 comprises memory controller 182, storage controller 184, DRAM controller 186, and flash controller 188 coupled to one another as shown. Coupled to DRAM controller 186 (e.g., as an integrated unit) are DRAM unit 190, flash buffer 192, virtualized storage 194, and virtualized memory 196. Coupled to flash controller 188 (e.g., as an integrated unit) are flash memory unit 198, DRAM buffer 200, virtualized storage 202, and virtualized memory 204.

Under system 180, direct memory access reaches DRAM 190 and DRAM buffer 200. Flash access is initiated by DRAM controller 186. DRAM controller 186 and flash controller 188 maintain one or more mappings (e.g., a memory to address mapping(s)). Virtualized memory access is translated to virtual addresses in DRAM 190 and flash memory 198. Flash memory 198 is accessed through memory controller 182, which also keeps a memory-level mapping.

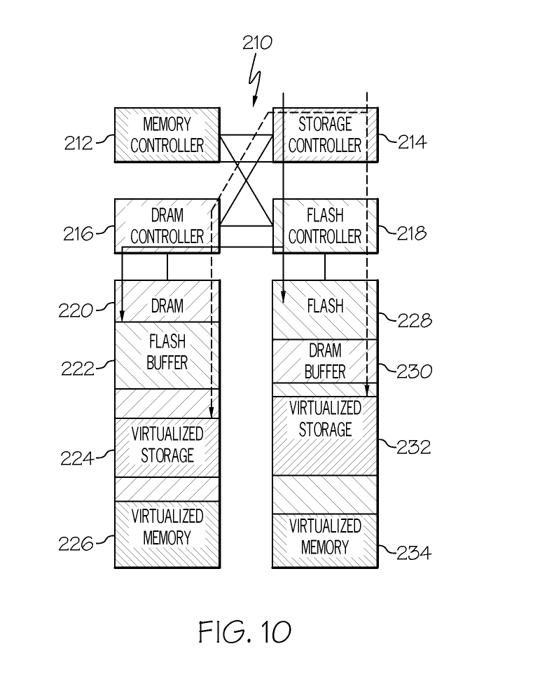

Referring now to FIG. 10, a system 210 having direct and virtualized storage access according to an embodiment of the present invention is depicted. As depicted, system 210 comprises memory controller 212, storage controller 214, DRAM controller 216, and flash controller 218 coupled to one another as shown. Coupled to DRAM controller 216 (e.g., as an integrated unit) are DRAM unit 220, flash buffer 222, virtualized storage 224, and virtualized memory 226. Coupled to flash controller 218 (e.g., as an integrated unit) are flash memory unit 228, DRAM buffer 230, virtualized storage 232, and virtualized memory 234.

Under system 210, direct flash access provides access to flash memory data designated in flash memory and DRAM areas. DRAM 220 access is initiated by flash controller 218. DRAM controller 216 and flash controller 218 maintain one or more mappings (e.g., memory to address mapping(s)). Virtualized storage access is mapped to virtually-mapped data in flash memory 228 and DRAM 220. Moreover, DRAM 220 is accessed through storage controller 214, which also maintains a storage-level mapping

It is understood that the embodiments discussed herein may apply to any heterogeneous semiconductor memory and storage technologies. Examples include DRAM and flash memory, SRAM and PRAM, MRAM and PRAM, etc. As such, FIGS. 1-10 and their associated descriptions (and claims) may be modified to substitute any such combination of memory and storage technologies.

The foregoing description of various aspects of the invention has been presented for purposes of illustration and description. It is not intended to be exhaustive or to limit the invention to the precise form disclosed and, obviously, many modifications and variations are possible. Such modifications and variations that may be apparent to a person skilled in the art are intended to be included within the scope of the invention as defined by the accompanying claims.

What is claimed is:

1. A converged memory and storage system, comprising:
at least one substrate;
a dynamic random access memory (DRAM) unit positioned on the at least one substrate;
a flash memory unit positioned on the at least one substrate;
a set of controllers coupled to the DRAM unit and the flash memory unit; and
a set of input/outputs (I/Os) coupled to the set of controllers for receiving requests to access the DRAM unit or the flash memory unit.

2. The converged memory and storage system of claim 1, the at least one substrate comprising a first substrate and a second substrate.

3. The converged memory and storage system of claim 2, the DRAM unit being positioned on the first substrate and the flash memory unit being positioned on the second substrate.

4. The converged memory and storage system of claim 1, the set of controllers comprising:
a DRAM controller coupled to the DRAM unit; and
a flash controller coupled to the flash memory unit.

5. The converged memory and storage system of claim 4, the set of controllers further comprising a main controller coupled to the DRAM controller and the flash controller.

6. The converged memory and storage system of claim 4, the set of controllers further comprising:
a memory controller coupled to the DRAM controller; and
a storage controller coupled to the flash controller.

7. The converged memory and storage system of claim 6, the set of I/Os comprising:
a first I/O coupled to the memory controller; and
a second I/O coupled to the storage controller.

8. The converged memory and storage system of claim 6, further comprising a decoder coupled to the memory controller and the storage controller, wherein the set of I/Os comprises an I/O coupled to the decoder.

9. The converged memory and storage system of claim 4, the set of I/Os comprising:
a DRAM I/O coupled to the DRAM controllers; and
a flash I/O coupled to the flash controllers.

10. A converged memory and storage system, comprising:
a first input/output (I/O);
a memory controller coupled to the first I/O;
a dynamic random access memory (DRAM) controller coupled to the memory controller;
a DRAM unit coupled to the DRAM controller;
a second I/O;
a storage controller coupled to the second I/O;
a flash controller coupled to the storage controller; and
a flash memory unit coupled to the flash controller.

11. The converged memory and storage system of claim 10, the memory controller further being coupled to the storage controller and the flash controller.

12. The converged memory and storage system of claim 10, the storage controller being further coupled to the DRAM controller and the memory controller.

13. The converged memory and storage system of claim 10, the DRAM controller and the flash controller further being coupled to one another.

14. The converged memory and storage system of claim 10, the first I/O and the second I/O being configured to:
receive memory and storage requests;
provide virtualized storage-level access to the DRAM unit and the flash memory unit.

15. A method for converged memory and storage operation, comprising:
virtualizing memory access across Dynamic Random Access Memory (DRAM) and flash memory via a memory controller;
virtualizing storage access across the DRAM and the flash memory via a storage controller;
maintaining a DRAM buffer in the flash memory via a flash controller and a DRAM controller; and
maintaining a flash buffer in the DRAM via the flash controller and the DRAM controller.

16. The method of claim 15, further comprising accessing the DRAM and the DRAM buffer via direct memory access.

17. The method of claim 15, maintaining a memory to storage mapping via the DRAM controller and the flash controller.

18. The method of claim 15, further comprising translating the virtualized memory access to a set of virtual addresses in the DRAM and the flash memory.

19. The method of claim 15, further comprising accessing the flash memory via the memory controller.

20. The method of claim 15, further comprising maintaining a memory-level mapping via the memory controller.
